(19) United States
(12) Patent Application Publication
(10) Pub. No.: US 2016/0188098 A1
(43) Pub. Date: Jun. 30, 2016

(54) TOUCH WINDOW AND TOUCH DEVICE

(71) Applicant: LG INNOTEK CO., LTD., Seoul (KR)

(72) Inventors: Jae Hak HER, Seoul (KR); Mun Suk KANG, Seoul (KR); Soung Kyu PARK, Seoul (KR); Do Youb KWON, Seoul (KR); Kyoung Jin KIM, Seoul (KR); Gyu Rin LEE, Seoul (KR); Gwang Hei CHOI, Seoul (KR); Beom Sun HONG, Seoul (KR)

(73) Assignee: LG INNOTEK CO., LTD.

(21) Appl. No.: 14/981,203

(22) Filed: Dec. 28, 2015

(30) Foreign Application Priority Data
Dec. 26, 2014 (KR) 10-2014-0190267
Dec. 26, 2014 (KR) 10-2014-0190413

(51) Int. Cl. G06F 3/041; G06F 3/047; G06F 1/16

(52) U.S. Cl. CPC G06F 3/0416; G06F 1/1652; G06F 3/047; G06F 3/0412; Y10S 977/742; Y10S 977/762; Y10S 977/834; B82Y 15/00

(57) ABSTRACT

A touch window is provided that may include a substrate including an active area, an unactive area and a folding area defined therein; a sensing electrode provided on the substrate; a wire electrode connected to the sensing electrode and provided on the substrate; and a printed circuit board connected to the wire electrode. The sensing electrode may include a first sensing electrode extending in a first direction, the first sensing electrode including a plurality of patterns, and a folding line serving as a center of the folding area is provided between the plurality of patterns of the first sensing electrode.

### CROSS-REFERENCE TO RELATED APPLICATIONS

This application claims priority under 35 U.S.C. §119 to Korean Patent Application Nos. 10-2014-0190267 filed on Dec. 26, 2014 and 10-2014-0190413 filed on Dec. 26, 2014, whose entire disclosures are incorporated herein by reference.

### BACKGROUND

1. Field

Embodiments disclosed herein relate to a touch window and a touch device.

2. Background

A touch window, which performs an input function through a touch of an image displayed on a display device by an input device, such as, e.g., a stylus pen or a finger, has been applied to various electronic appliances.

The touch window may be classified, for example, as a resistive touch window or a capacitive touch window. In the resistive touch window, a position of a touch point may be detected by detecting a variation of resistance according to a connection between electrode parts or components when pressure is applied to an input device. In the capacitive touch window, a position of a touch point may be detected by detecting a variation in capacitance between electrode parts or components when a user touches the capacitive touch window.

In resistive touch windows, repeated use may degrade performance and may cause scratches. Accordingly, interest in capacitive touch windows, which may have superior endurance and a long life span, has increased.

Recently, a flexible display has been highlighted as the flexible display may replace current display types. The flexible display may be a bendable display device. The flexible display may be folded or unfolded by replacing the glass substrate of a liquid crystal display (LCD) or organic light emitting diode (OLED) with a plastic film to add flexibility to the liquid crystal display (LCD) or organic light emitting diode (OLED).

The flexible display is thin, light and strong. The flexible display may also be curved or bended and may be manufactured in various shapes. In addition to a flexible display, foldable, bendable and stretchable displays have been developed.

Thus, there is a need for a touch window that may serve as an interface on a flexible display.

### BRIEF DESCRIPTION OF THE DRAWINGS

The embodiments will be described in detail with reference to the following drawings in which like reference numerals refer to like elements wherein:

FIG. 1 is a plan view showing a touch window according to an embodiment;

FIGS. 2 to 5 are plan views showing a touch window according to another embodiment;

FIG. 6 is a perspective view showing a touch device to which a touch window is applied according to an embodiment;

FIG. 7 is a sectional view of a folding area of a touch device according to an embodiment;

FIG. 8 is a sectional view of a folding area when the touch device of FIG. 7 is folded;

FIG. 9 is a perspective view showing a touch window according to an embodiment;

FIG. 10 is a plan view showing a second sensing electrode of the touch window of FIG. 9;

FIG. 11 is a plan view showing a second sensing electrode of the touch window of FIG. 9 according to another embodiment;

FIG. 12 is a plan view showing a second sensing electrode of the touch window of FIG. 9 according to still another embodiment;

FIG. 13 is a plan view showing a first sensing electrode of the touch window of FIG. 9;

FIG. 14 is a plan view showing a first sensing electrode of the touch window of FIG. 9 according to still another embodiment;

FIG. 15 is a perspective view showing a touch window according to still another embodiment;

FIG. 16 is a perspective view showing a touch window according to still another embodiment;

FIG. 17 is a perspective view showing a touch window according to still another embodiment;

FIG. 18 is a plan view of a substrate of the touch window of FIG. 17;

FIGS. 19 to 22 are sectional views of a touch window including a display panel according to still another embodiment;

FIG. 23 is an exploded perspective view of a touch window including a display panel according to still another embodiment;

FIG. 24 is a sectional view taken along line A-A′ of FIG. 23;

FIGS. 25 to 28 are sectional views taken along line A-A′ of FIG. 23 according to still another embodiment; and

FIGS. 29 to 32 are views showing examples of a touch device to which a touch window is applied according to embodiments.

### DETAILED DESCRIPTION

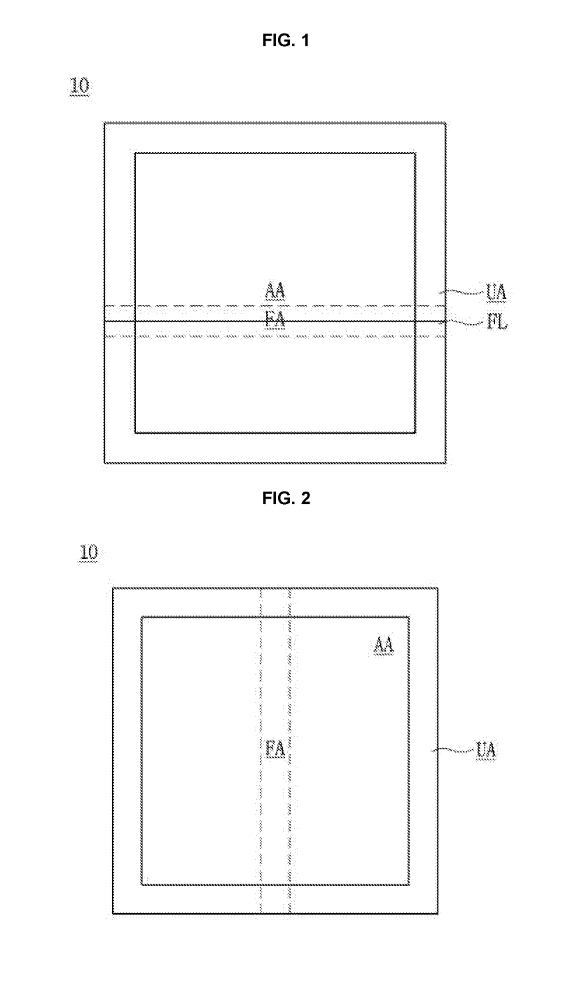

FIG. 1 is a plan view showing a touch window according to an embodiment. FIGS. 2 to 5 are plan views showing a touch window according to another embodiment.

Referring to FIGS. 1 to 5, a touch window 10 may include an active area AA, an unactive area UA and a folding area FA defined therein. An image may be displayed in the active area AA. The image may not be displayed in the unactive area UA, which may be provided at a peripheral portion of the active area AA. A position of an input device or finger may be sensed through the active area AA.

A sensing electrode may be provided on the active area AA to sense an input device. A wire electrode electrically connected to the sensing electrode and an external circuit connected to the wire electrode may be provided on the unactive area UA.

A folding area FA may be defined in at least a portion of the active area AA and at least a portion of the unactive area UA. The folding area FA may be folded when the touch window is folded. That is, the folding area may correspond to an area folded when the touch window is folded.

The folding area FA may be a curved or bended area. That is, the folded area FA may correspond to an area curved or bended when a portion of the touch window is curved or bended. For example, in the folding area FA, an end of the substrate may be bent to have a curved surface or may be bent or flexed to have a surface including a random curvature.

Referring to FIG. 1, when viewed from above, the folding area FA may be provided to allow a longitudinal direction of the folding area FA to be parallel with a direction, for example, a transverse direction, of the touch window. That is, the touch window may be divided into upper and lower parts based on the folding area FA. Thus, as the touch window is folded on the folding area FA, an upper end of the touch window may become close to a lower end of the touch window. When the touch window is fully folded, the upper end of the touch window may contact the lower end of the touch window.

A folding line FL passing through the center of the folding area FA may be defined. If the folding area FA is defined based on the folding line FL, when the touch window is folded on the basis of the folding line FL, the bended or folded area of the touch window may be understood as the folding area FA. The folding area may be provided on the central portion of the touch window. When the folding area FA is provided at a central portion of the touch window and the touch window is folded, a side length, for example, a longitudinal length, of the touch window may be shortened so that the touch window may be easily portable and may be stabilized in design.

Referring to FIG. 2, according to the touch window of an embodiment, the folding area FA may be provided in a longitudinal direction of the touch window. That is, the touch window may be divided into left and right areas based on the folding area FA.

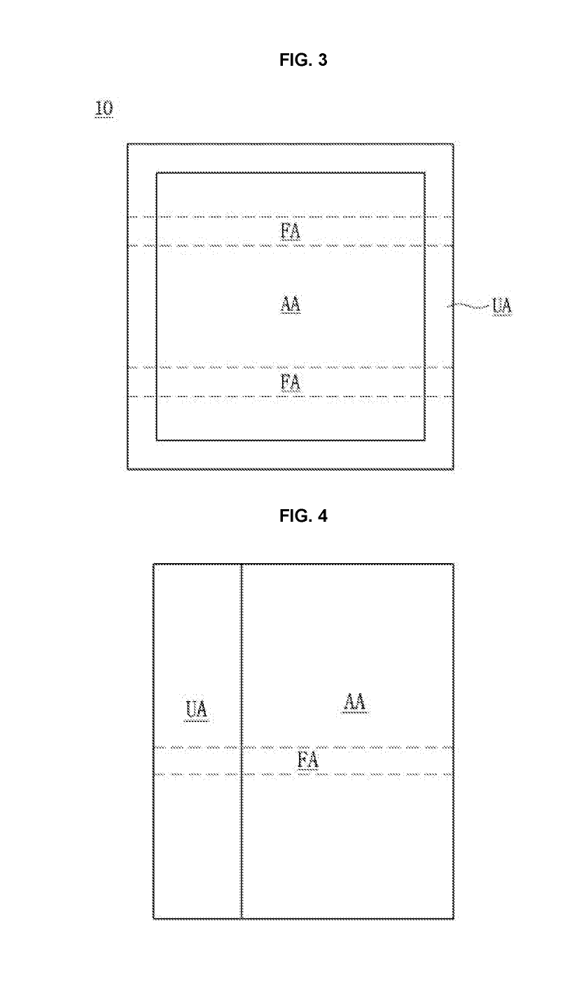

Referring to FIG. 3, the touch window according to another embodiment may include at least two folding areas FA. The at least two folding areas FA may be symmetrical to each other with respect to the central line of the touch window. When the touch window is folded, a side length of the touch window may be shortened so that the touch window may be easily portable.

Referring to FIG. 4, in the touch window according to still another embodiment, the unactive area UA may be provided on one of four side surfaces of the active areas AA. Since the unactive area UA is provided on one side surface of the touch window, limitations in design may be overcome and a bezel may be reduced.

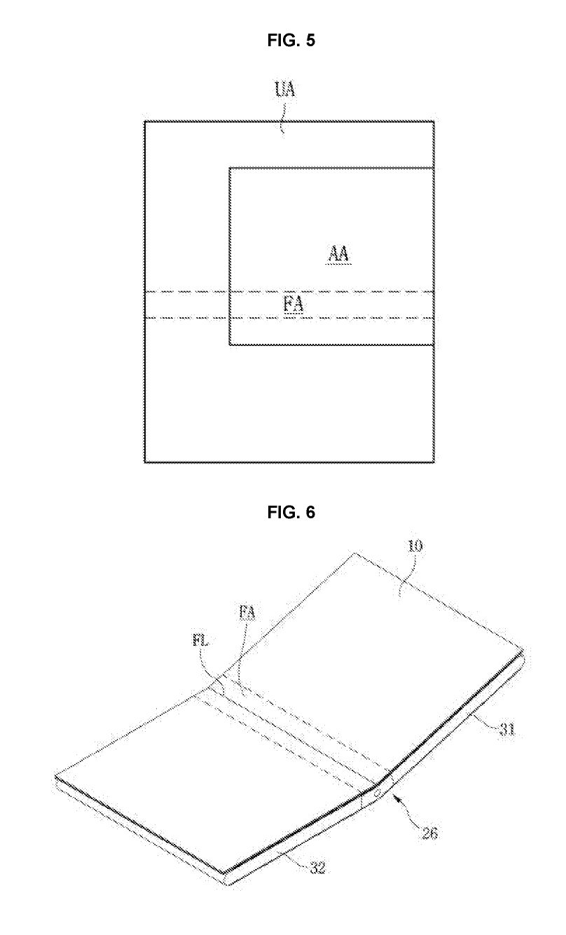

Referring to FIG. 5, the unactive area UA may be provided on three of four side surfaces of the active area AA. That is, the unactive area UA may be provided on the active area AA except for one side surface of the active area AA.

In addition, the unactive area UA may be provided on two of four side surfaces of the active area AA. In this case, a bezel may not be necessary on one side of the touch window, thus reducing the bezel, which may be suitable for a one-hand usable device. As described above, by providing the unactive area UA and the folding area FA in various configurations, a flexible area of the touch window may be variously implemented.

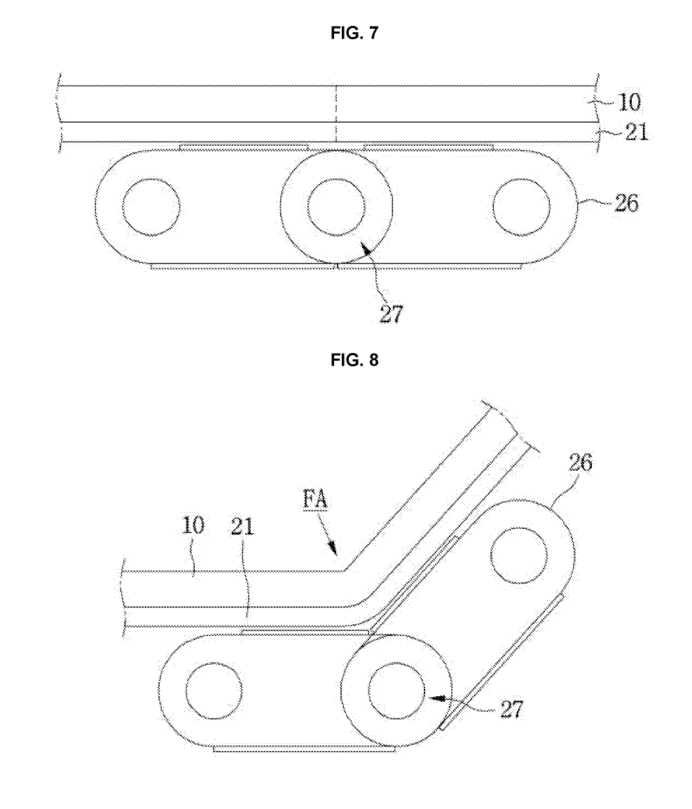

FIG. 6 is a perspective view showing a touch device to which a touch window is applied according to an embodiment. FIG. 7 is a sectional view of a folding area FA of a touch device according to an embodiment. FIG. 8 is a sectional view of a folding area FA when the touch device of FIG. 7 is folded.

Referring to FIGS. 6 to 8, a touch device according to an embodiment may include a main body 31 and 32, a touch window 10 provided on the main body 31 and 32, and a folding member 26 for folding the touch device. The touch device according to an embodiment may include a main body 31 and 32 forming a case, a touch window 10 configured to be foldable, and a folding member 26 provided on the touch window 10 to adjust the folding and unfolding of the touch window 10.

The main body 31 and 32 may include an elastic plate 21 provided on a rear surface of the touch window 10, but the embodiment is not limited thereto. The touch window 10 may include a flexible display panel, but the embodiment is not limited thereto. The touch window 10 may have a rectangular shape and have a wide screen in which a horizontal width is longer than a vertical width. However, the embodiment is not limited to the above and the touch window 10 may have various shapes, such as, e.g., an elliptical shape, a circular shape, a triangular shape or a diamond shape, when the touch window 10 is unfolded.

A folding area FA may be defined in the touch window 10. The folding member 26 may be provided on the main body 31 and 32 corresponding to the folding area FA. For example, the folding member 26 may be provided on the main body 31 and 32 which overlaps a rear surface of the folding area FA of the touch window 10.

That is, the main body 31 and 32 may be divided into upper and lower main bodies 31 and 32 about the folding member 26. As shown in FIGS. 6 to 8, the touch window 10 may be flexible so that the touch window 10 may be foldable after being integrally formed. Alternatively, the touch window 10 may be divided into a first touch window provided on the upper main body 31 and a second touch window provided on the lower main body 32.

The folding member 26 may include a hinge 27. That is, the folding member 26 may be formed to have the hinge 27 connecting the upper and lower main bodies 31 and 32 to each other so that the touch device may be folded or unfolded.

Referring to FIGS. 7 and 8, the touch device may be folded or unfolded based on the folding member 26, and the folding area FA may be provided on the folding member 26. That is, the folding area FA may be an area of the touch window 10 corresponding to the folding member 26 of the touch device.

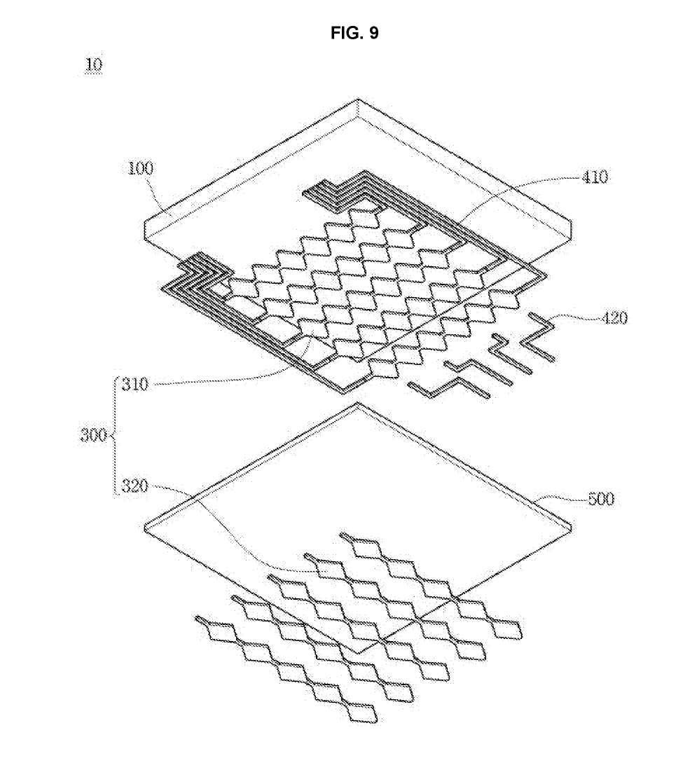

Hereinafter, touch windows each including a folding area FA according to various embodiments will be described with reference to FIGS. 9 to 28. Referring to FIGS. 9 to 14, a touch window 10 according to an embodiment may include a substrate 100, a sensing electrode 300 and a wire electrode 400. At least a portion of the substrate 100 may be flexible. That is, an area defined in the substrate 100 as the folding area FA may be flexible. For example, the substrate 100 may include glass or plastic. The substrate 100 may include chemically tempered/half-tempered glass such as, e.g., soda lime glass or aluminosilicate glass, reinforced or flexible plastic such as, e.g., polyimide (PI), polyethylene terephthalate (PET), propylene glycol (PPG), or polycarbonate (PC), or sapphire. Sapphire has superior electric characteristics, such as permittivity, so that a touch response speed may be greatly increased and a space touch, such as hovering, may be easily implemented. Hovering refers to a technique of recognizing coordinates even at a slight distance from a display. Since sapphire has high surface hardness, sapphire may be applicable to a cover substrate.

The substrate 100 may include an optically isotropic film. For example, the substrate 100 may include cyclic olefin copolymer (COC), cyclic olefin polymer (COP), optically isotropic polycarbonate (PC), or optically isotropic polymethyl methacrylate (PMMA).

In addition, a portion of the substrate 100 may be curved with a partial curved surface. That is, a portion of the substrate 100 may have a flat surface, and another portion of the substrate 100 may be curved with a curved surface. An end portion of the substrate 100 may be curved with a curved surface or may be curved or bent with a surface having a random curvature.

The substrate 100 may include a foldable substrate 100, a portion of which is foldable or unfoldable. In addition, the substrate 100 may include a flexible substrate having a flexible property. Alternatively, the substrate 100 may be rigid. In this case, the substrate 100 may include at least two rigid substrates 100. For example, the substrate 100 may be divided into upper and lower substrates based on the folding area. The upper and lower substrates may be connected to each other through a separated member, for example, the above-described folding member. That is, the rigid substrate 100 may be folded or unfolded by dividing the substrate 100 based on the folding area.

The substrate 100 may include a curved or bended substrate. That is, a touch window including the substrate 100 may be formed to have a flexible, curved or bendable property. Thus, the touch window according to the embodiments may be easily portable and may vary in design.

The sensing electrode 300, the wire electrode 400 and the printed circuit board 450 may be provided on the substrate 100. That is, the substrate 100 may serve as a support substrate. The substrate 100 may include a cover substrate. That is, the sensing electrode 300, the wire electrode 400 and the printed circuit board 450 may be supported by the cover substrate. Alternatively, an additional cover substrate may be further provided on the substrate 100. That is, sensing electrode 300, the wire electrode 400 and the printed circuit board 450 may be supported by the substrate 100, and the substrate 100 and the cover substrate may be combined with or adhered to each other through an adhesive layer.

The substrate 100 may have an active area AA, an unactive area UA and a folding area FA defined therein. An image may be displayed on the active area AA. The image may not be displayed on the unactive area UA provided at a peripheral portion of the active area AA. A position of an input device or a finger may be sensed in at least one of the active area AA and the unactive area UA. If the input device or a finger touches the touch window, variation of capacitance may occur in the touched part or portion by the input device, and the touched portion, subject to the variation of capacitance, may be detected as a touch point.

An outer dummy layer may be provided on the unactive area UA of the substrate 100. The outer dummy layer may be formed by coating with a material which may have a predetermined color to prevent a printed circuit board, through which a wire may be connected to an external circuit, from being visible to an outside.

The outer dummy layer may have a color suitable for a desired outer appearance thereof. For example, the outer dummy layer may include a black or white pigment to have a black or white color. Alternatively, various colors, such as, e.g., red or blue may be shown by using various color films. A desired logo may be formed in the outer dummy layer through various schemes. The outer dummy layer may be formed through, for example, a deposition, print, or wet coating scheme. The outer dummy layer may include at least one layer. For example, the outer dummy layer may consist of one layer or at least two layers having mutually different widths.

The sensing electrode 300 may be provided on the substrate 100. The sensing electrode 300 may include the first sensing electrode 310 extending in a first direction and the second sensing electrode 320 extending in a second direction. Alternatively, the first sensing electrode 310 may extend in the second direction and the second sensing electrode 320 may extend in the first direction.

The first sensing electrode 310 extending in the first direction may be provided on the substrate. That is, electrode patterns (hereinafter, referred to as “patterns of the first sensing electrode 310”) constituting the first sensing electrode 310 extending in the first direction may be arrayed on the substrate in the second direction. In this case, the first direction may be perpendicular to the second direction, but the embodiment is not limited thereto.

Although the pattern of the first sensing electrode 310 is provided in a rhombus shape in the drawings, the embodiment is not limited thereto and the pattern of the first sensing electrode 310 may be formed in various shapes such as, e.g., a bar shape, a polygonal shape including a triangular shape and a rectangular shape, a circular shape, a linear shape, an H-shape or an elliptical shape. The first sensing electrode 310 may include a bar pattern connecting the adjacent patterns having the rhombus shape to each other.

The sensing electrode 300 may include a transparent conductive material that allows electricity to flow therethrough without interrupting transmission of light. For example, the sensing electrode may include metal oxide such as indium tin oxide (ITO), indium zinc oxide (IZO), copper oxide, tin oxide, zinc oxide, or titanium oxide. The sensing electrode 300 may include a nano wire, a photo sensitive nano wire film, a carbon nano tube (CNT), graphene, conductive polymer or a mixture thereof. The sensing electrode 300 may include various metals. For example, the sensing electrode 300 may include at least one of Cr, Ni, Cu, Al, Ag, Mo, Au, Ti and the alloy thereof.

The sensing electrode 300 or wire electrode 400 may be formed in a mesh shape. That is, the sensing electrode 300 may include a plurality of sub-electrodes which cross each other in a mesh shape. The sensing electrodes 300 may include mesh lines LA by the sub-electrodes crossing each other in a mesh shape and a mesh opening part or portion OA between the mesh lines LA.

The mesh opening part or portion OA may have various shapes. For example, the mesh opening part or portion OA may have a polygonal shape including a rectangular shape, a diamond shape, a pentagon shape, or a hexagonal shape, or a circular shape. In addition, the mesh opening part or portion OA may have a regular shape or a random shape.

The sensing electrode 300 may have a mesh shape so that the pattern of the sensing electrode 300 may not be viewed on the active area, for example, a display area. That is, even though the sensing electrode 300 may be formed of metal, the pattern may not be viewed. In addition, even if the sensing electrode 300 is applied to a large-size touch window, the resistance of the touch window may be lowered.

According to embodiments disclosed herein, the longitudinal direction of the first sensing electrode 310 extending in the first direction may be equal to that of the folding area FA. The first sensing electrode 310 may include metal oxide having excellent visibility such as, e.g., indium tin oxide (ITO), indium zinc oxide (IZO), copper oxide, tin oxide, zinc oxide, or titanium oxide. However, the metal oxide may be weak in the folding stress applied when the touch window is folded or unfolded.

Thus, the folding area FA may be provided between the patterns of the first sensing electrode 310 in the substrate 100. That is, by providing the folding area FA, in which the folding stress may be at a maximum when the touch window is folded, between the patterns of the first sensing electrode 310, the folding stress applied to the first sensing electrode 310 may be minimized.

The folding area FA may be provided on a central portion of the mutually adjacent patterns of the first sensing electrode 310 and may be provided between the patterns of the first sensing electrode 310. In this case, if the width of the folding area FA is greater than a length between the patterns of the first sensing electrode 310, a portion 311 of the first sensing electrode 310 may be provided in the folding area FA, but the embodiment is not limited.

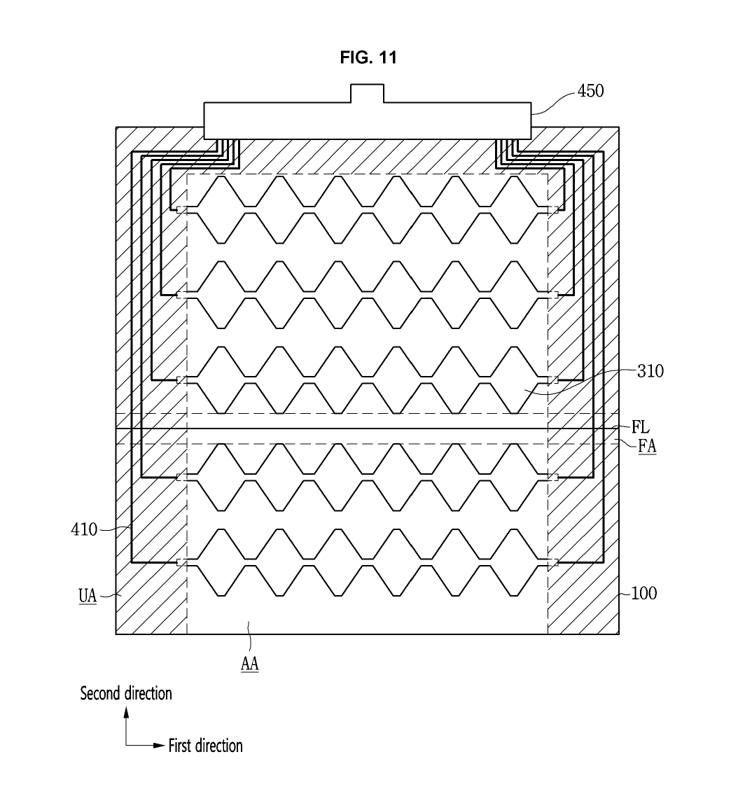

Referring to FIG. 11, according to another embodiment, the width between the patterns of the first sensing electrode 310 in which the folding area FA is provided may be larger than the width of the folding area FA. That is, the widths between the patterns of the first sensing electrode 310 may be different from each other.

The width between the patterns of the first sensing electrode 310 in which the folding area FA is provided may be larger than the width between the patterns of the first sensing electrode 310. That is, the patterns of the first sensing electrode 310 may be provided to allow the width between the patterns of the first sensing electrode 310 provided in the folding area FA to be larger than the width of the folding area FA, so that the folding stress applied to the first sensing electrode 310 may be further reduced.

An intermediate layer 500 may be provided on the substrate 100. The intermediate layer 500 may include a material different from a material of the substrate 100. For example, the intermediate layer 500 may include a flexible dielectric substance. The intermediate layer 500 may surround the sensing electrode 300 during folding to absorb folding stress so that reliability of the touch window may be improved.

For example, the intermediate layer 500 may include an insulating group including halogen compounds of alkali metals or alkali earth metals, such as, e.g., LiF, KCl, CaF₂, or MgF₂, or fused silica, such as SiO₂, SiN_{X}; a semiconductor group including InP or InSb; transparent oxide used for semiconductors or dielectric substances including In compounds, such as ITO or IZO, mainly used for a transparent electrode, or transparent oxide used for semiconductor or dielectric substance, such as ZnOₓ, ZnS, ZnSe, TiOₓ, WOₓ, MoOₓ, or ReOₓ; an organic semiconductor group including Alq3, NPB, TAPC, 2TNATA, CBP or Bphen; and a low-K material such as silsesquioxane or a derivative ((H—SiO_{3/2)n}) thereof, methylsilsesquioxane (CH₃—SiO_{3/2})n), porous silica or porous silica doped with fluorine or carbon atoms, porous zinc oxide (ZnOₓ), cyclized-perfluoropolymer (CYTOP) or a mixture thereof.

In addition, the intermediate layer 500 may have visible ray transmittance of about 75% to about 99%. A thickness of the intermediate layer 500 may be less than that of the substrate 100. That is, the thickness of the intermediate layer 500 may be about 0.01 to about 0.1 times that of the substrate 100. For example, the thickness of the substrate 100 may be about 0.1 mm and the thickness of the intermediate layer 500 may be about 0.001 mm.

In addition, a cross-section area of the intermediate 500 may be different from that of the substrate 100. That is, the cross-section area of the intermediate 500 may be smaller than that of the substrate 100.

The intermediate layer 500 may be directly provided on a top surface of the substrate 100. That is, the intermediate layer 500 may be formed by directly coating a dielectric material on the top surface of the substrate 100 on which the first sensing electrode 310 is provided. Then, the second sensing electrode 320 extending in the second direction may be provided on the intermediate layer 500.

The wire electrode 400 may be connected to the sensing electrode 300. The first wire electrode 410 may be connected to the first sensing electrode 310 and may be provided on the unactive area UA. The second wire electrode 420 may be connected to the second sensing electrode 320 and may be provided on the unactive area UA. All of the first and second wire electrodes 410 and 420 may be provided on the unactive area UA of the substrate 100, but the embodiment is not limited thereto.

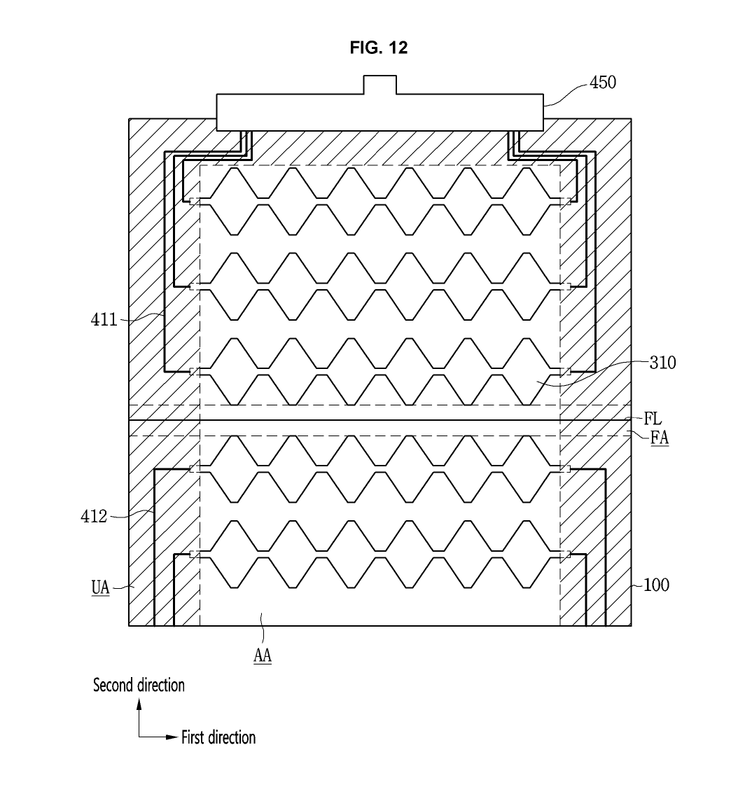

Referring to FIG. 12, according to still another embodiment, the first wire electrode 410 may include first and second sub-wire electrodes 411 and 412. The first sensing electrode 310 provided on an upper part of the substrate 100 divided by the folding line FL may be connected to the first sub-wire electrode 411, and the first sensing electrode 310 provided on a lower part of the substrate 100 may be connected to the second sub-wire electrode 412.

The first and second sub-wire electrodes 411 and 412 may have different withdrawal directions. That is, according to still another embodiment, the first sensing electrodes 310 provided on the upper and lower parts of the substrate 100 with respect to the folding line FL may be connected to the wire electrodes 421 and 422 having separated withdrawal directions, respectively.

The first and second sub-wire electrodes 411 and 422 may be connected to different printed circuit boards. That is, the touch window may be provided with separated upper and lower printed circuit boards, such that the first wire electrode 410 may not be provided on the folding area FA. Thus, the touch window according to still another embodiment may prevent folding stress from being applied to the first wire electrode 410, so that reliability may be improved.

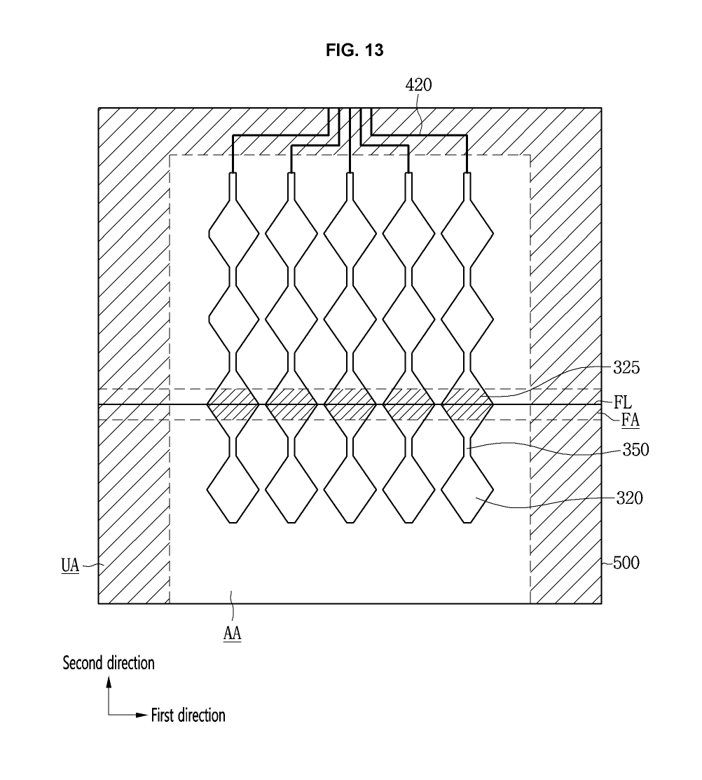

Referring to FIG. 13, the second sensing electrode 320 extending in the second direction may include an area 325 which overlaps the folding area FA extending in the first direction. Thus, the second sensing electrode 320 may receive the folding stress when the touch window is folded.

In order to prevent the second sensing electrode 320 from being damaged due to the folding stress, at least a part of the second sensing electrode 320 may include, for example, a nano wire, a photo sensitive nano wire film, a carbon nano tube (CNT), graphene, conductive polymer or a mixture thereof, which may be highly resistant to physical stress.

Alternatively, the second sensing electrode 320 may include a mesh shape. The second sensing electrode 320 may include a plurality of sub-electrodes which cross each other in a mesh shape. The second sensing electrode 320 having a mesh shape may include various metals. For example the second sensing electrode 320 may include at least one of Cr, Ni, Cu, Al, Ag, Mo, Au, Ti and the alloy thereof.

That is, according to an embodiment, the first and second sensing electrodes 310 and 320 may include different materials. As described above, the first sensing electrode 310 may include metal oxide for improving visibility. The second sensing electrode 320 may include a nano wire, a photo sensitive nano wire film, a carbon nano tube (CNT), graphene, conductive polymer or a mixture thereof, which may be highly resistant to physical stress, and may be formed of metal having a mesh shape, but the embodiment is not limited thereto.

The entire second sensing electrode 320 may be formed of a material or in a structure highly resistant to physical stress, or a part or portion 325, which overlaps the folding area FA in the second sensing electrode 320, may be formed of a material or in a structure highly resistant to physical stress.

Alternatively, the longitudinal direction of the folding area FA may be the second direction. In this case, the folding area FA may be provided between the patterns of the second sensing electrode 320, and the first sensing electrode 310 may include a material highly resistant to physical stress.

The touch window 10 according to embodiments may prevent the sensing electrode 300 from being damaged due to the folding stress so that reliability may be improved. In addition, at least a portion of the sensing electrode 300 of the touch window according to embodiments may be formed of a material having good visibility so that the visibility is improved.

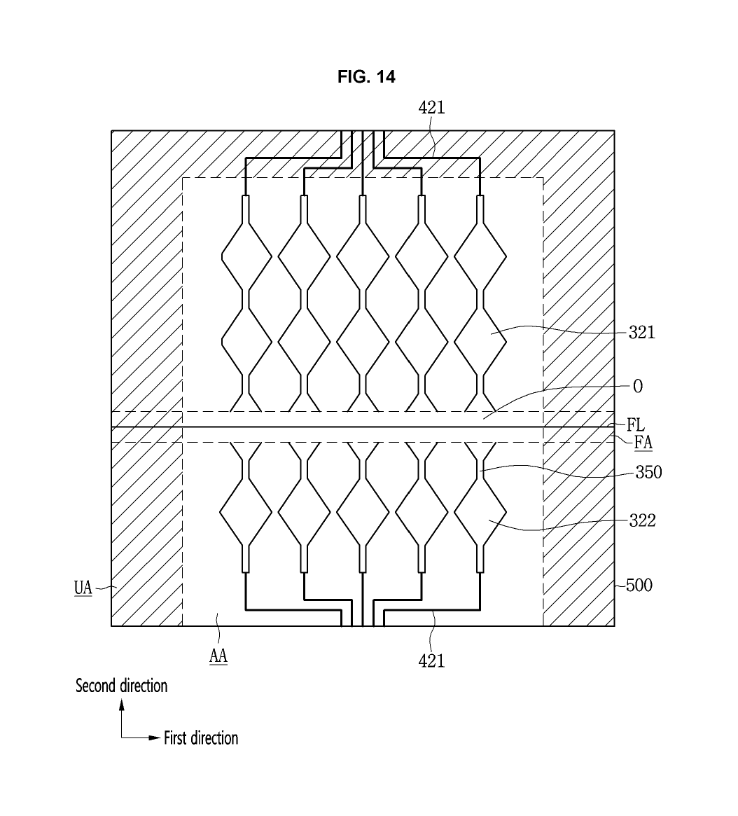

Referring to FIG. 14, the second sensing electrode 321 and 322 may not be provided on the folding area FA. The second sensing electrode 321 and 322 may include an upper second sensing electrode 321 provided on the intermediate layer 500 and a lower second sensing electrode 322 provided below the intermediate layer 500. That is, the second sensing electrode 321 and 322 may include an opening part or portion O provided on the folding area FA.

The second wire electrode 421 and 422 may include an upper second wire electrode 421 connected to the upper second sensing electrode 321 and a lower second wire electrode 422 connected to the lower second sensing electrode 322. The second wire electrode 421 and 422 may be connected to the same printed circuit board 450.

Alternatively, the upper and lower second wire electrodes 421 and 422 may be connected to different printed circuit boards 450. For example, separated printed circuit boards 450 may be provided on upper and lower parts of the touch window, and the second wire electrodes 421 and 422 may be connected to the separated printed circuit boards 450, respectively.

Since the second sensing electrode 321 and 322 according to still another embodiment is not provided on the folding area FA, the second sensing electrode 321 and 322 may not receive any folding stress. Thus, the second sensing electrode 321 and 322 may not be limited in its constituent materials, and the second sensing electrode 321 and 322 may include metal oxide having good visibility.

In the following descriptions, parts or components similar or identical to those of previously described embodiments have been omitted for the purpose of clear and brief description, and same reference numbers have been assigned to same elements.

FIG. 15 is a perspective view showing a touch window according to still another embodiment. Referring to FIG. 15, a touch window 10 according to still another embodiment may include a substrate 100 including a first substrate 101 and a second substrate 102 on the first substrate 101, a first sensing electrode 310 on the first substrate 101, and a second sensing electrode 320 on the second substrate 102. That is, the touch window according to still another embodiment may include the second substrate 102 instead of the intermediate layer 500 of the touch window of embodiments described above.

The second substrate 102 may be formed of a flexible material capable of enduring the folding stress. For example, the second substrate 102 may include chemically tempered/half-tempered glass such as, e.g., soda lime glass or aluminosilicate glass, reinforced or flexible plastic such as polyimide (PI), polyethylene terephthalate (PET), propylene glycol (PPG), or polycarbonate (PC), or sapphire. Alternatively, the second substrate 102 may include an optically isotropic film. For example, the second substrate 102 may include cyclic olefin copolymer (COC), cyclic olefin polymer (COP), optically isotropic polycarbonate (PC), or optically isotropic polymethyl methacrylate (PMMA). The first substrates 101 may be a cover substrate. The first and second substrates 101 and 102 may be bonded to each other through optical clear adhesive (OCA).

Since the folding stress is reduced by providing the folding area FA between the patterns, the first sensing electrode 310 may include metal oxide having excellent visibility, such as, e.g., indium tin oxide (ITO), indium zinc oxide (IZO), copper oxide, tin oxide, zinc oxide, or titanium oxide.

Alternatively, when the touch window is folded, folding stress may be applied to the second sensing electrode 320. In order to prevent the second sensing electrode 320 from being damaged due to the folding stress, at least a part of the second sensing electrode 320 may include a nano wire, a photo sensitive nano wire film, a carbon nano tube (CNT), graphene, conductive polymer or a mixture thereof, which may be highly resistant to physical stress.

The touch window according to still another embodiment may prevent the sensing electrode 300 from being damaged due to the folding stress, so that the reliability may be improved. In addition, at least a portion of the sensing electrode 300 of the touch window may be formed of a material having good visibility so that visibility may be improved.

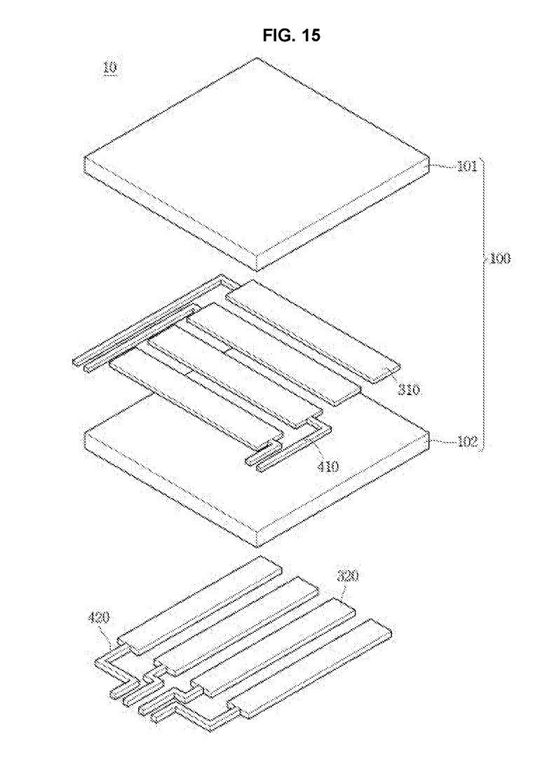

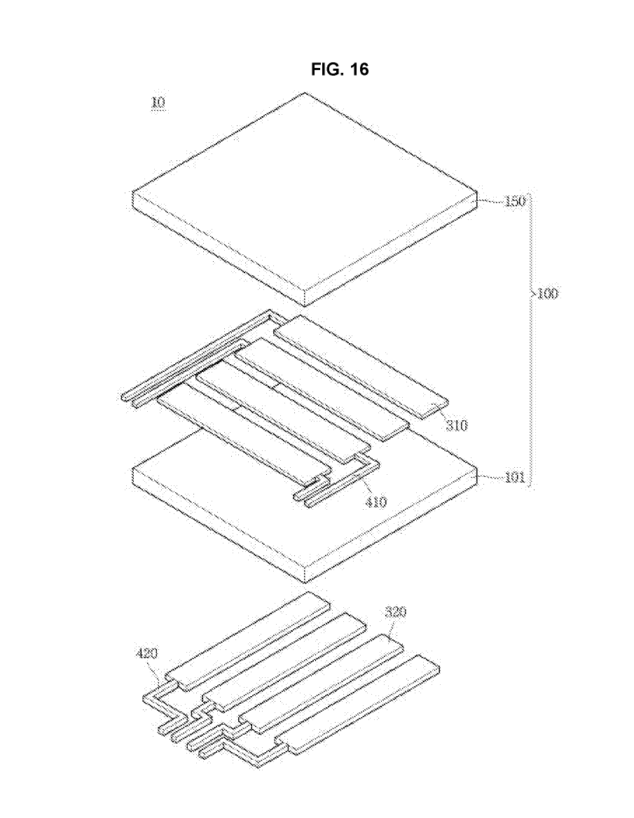

FIG. 16 is a perspective view showing a touch window according to still another embodiment. Referring to FIG. 16, a touch window according to still another embodiment may include a cover substrate 150, a substrate 100 including a first substrate 101, a first sensing electrode 310 on one surface of the first substrate 101, and a second sensing electrode 320 on the opposite surface of the first substrate 101.

The first sensing electrode 310 may be provided on one surface of the first substrate 101 and the second sensing electrode may be provided on the opposite surface of the first substrate 101. The cover substrate 150 and the first substrates 101 may be bonded to each other through optical clear adhesive (OCA).

Since the folding stress is reduced by providing the folding area FA between the patterns, the first sensing electrode 310 may include metal oxide having excellent visibility, such as, e.g., indium tin oxide (ITO), indium zinc oxide (IZO), copper oxide, tin oxide, zinc oxide, or titanium oxide.

Alternatively, when the touch window is folded, folding stress may be applied to the second sensing electrode 320. In order to prevent the second sensing electrode 320 from being damaged due to the folding stress, at least a part of the second sensing electrode 320 may include a nano wire, a photo sensitive nano wire film, a carbon nano tube (CNT), graphene, conductive polymer or a mixture thereof, which is highly resistant to physical stress.

The touch window according to still another embodiment may prevent the sensing electrode 300 from being damaged due to the folding stress so that reliability may be improved. In addition, at least a portion of the sensing electrode 300 of the touch window may be formed of a material having good visibility so that visibility may be improved.

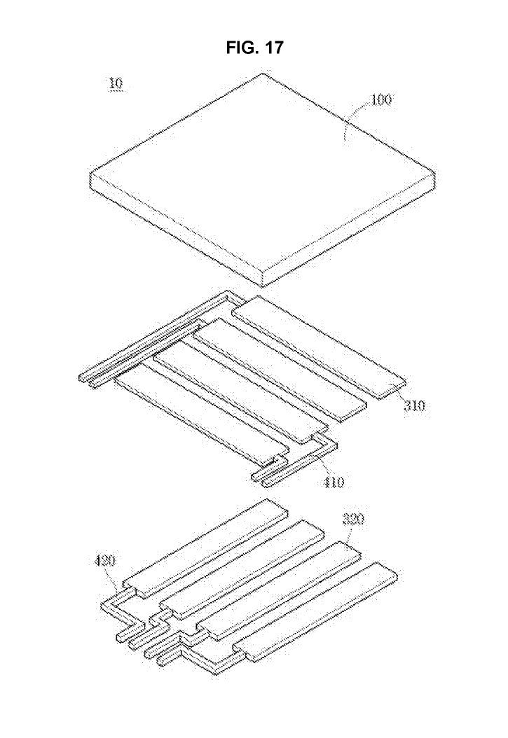

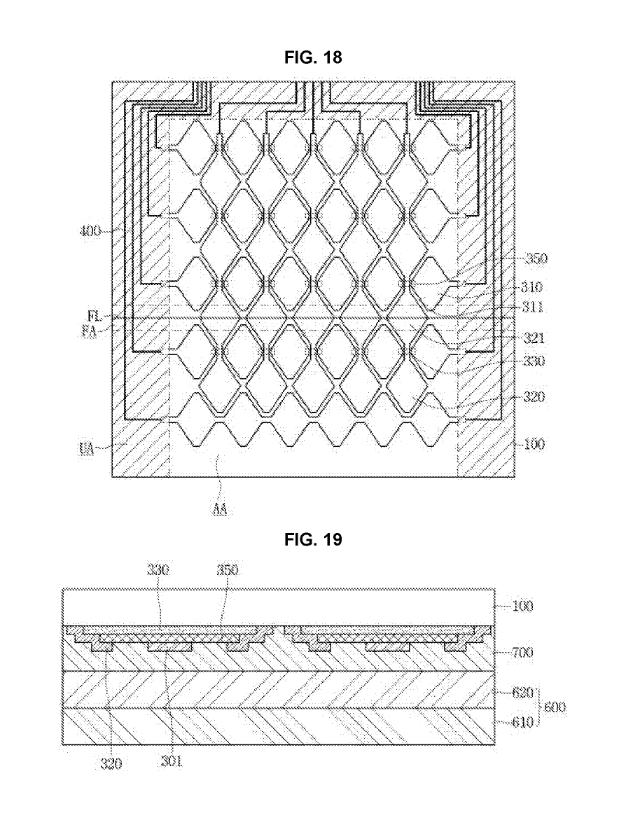

FIG. 17 is a perspective view showing a touch window according to still another embodiment. FIG. 18 is a plan view of the substrate 100 of the touch window of FIG. 17. A touch window according to still another embodiment may include a substrate 100, a first sensing electrode 310 on the substrate 100, and a second sensing electrode 320 on the substrate 100.

The substrate 100 may be a cover substrate. The first sensing electrode 310 may be provided on the active area AA of the cover substrate while extending in a first direction. The first sensing electrode 310 may be provided to make direct contact with the cover substrate. In addition, the second sensing electrode 320 may be provided on the active area AA of the cover substrate while extending in a second direction. The second sensing electrode 320 may extend in the second direction different from the first direction and may be provided to make direct contact with the cover substrate. That is, the first and second sensing electrodes 310 and 320 may be provided to make direct contact with a same surface of the cover surface and may extend in different directions on the same surface of the cover substrate. The first and second sensing electrodes 310 and 320 may be provided on the cover substrate while being insulated from each other.

A bridge electrode 330 may be provided on one surface of the cover substrate on which the sensing electrode 300 is provided. For example, the bridge electrode 330 may be provided in a bar shape. Bridge electrodes 330 may be spaced apart from each other by a predetermined interval on the active area AA in the bar form.

An insulating material 350 may be provided on the bridge electrode 330. The insulating material 350 may be partially provided on the bridge electrode 330 and a part or portion of the bridge electrode 330 may be coated with the insulating material 350. For example, when the bridge electrode 330 is formed in a bar form, the insulating material 350 may be provided on an area except for a first end and an opposite second end, that is, both ends of the bridge electrode 330.

The first sensing electrodes 310 may extend while being connected to each other on the insulating material. For example, the first sensing electrodes 310 extending in the first direction may extend while being connected to each other on the insulating material.

The second sensing electrodes 320 may be connected to a bridge electrode 330. That is, the second sensing electrodes 320 spaced apart from each other may be connected to the bridge electrode 330 such that the second sensing electrodes 320 may be provided to extend in the second direction.

Thus, the first and second sensing electrodes 310 and 320 may be electrically connected to the bridge electrode without being short-circuited with each other due to the insulating material.

Referring to FIG. 18, the folding area FA may be provided between the patterns of the first sensing electrode 310. At least a part or portion of the pattern of the second sensing electrode 320 may be provided on the folding area FA.

Since the folding stress is reduced by providing the folding area FA between the patterns, the first sensing electrode 310 may include metal oxide having excellent visibility, such as, e.g., indium tin oxide (ITO), indium zinc oxide (IZO), copper oxide, tin oxide, zinc oxide, or titanium oxide.

Alternatively, when the touch window is folded, folding stress may be applied to the second sensing electrode 320. In order to prevent the second sensing electrode 320 from being damaged due to the folding stress, at least a part or portion of the second sensing electrode 320 may include a nano wire, a photo sensitive nano wire film, a carbon nano tube (CNT), graphene, conductive polymer or a mixture thereof, which is highly resistant to physical stress.

The touch window according to still another embodiment may prevent the sensing electrode 300 from being damaged due to the folding stress so that reliability may be improved. In addition, at least a portion of the sensing electrode 300 of the touch window according to an embodiment may be formed of a material having good visibility so that visibility may be improved. According to the touch window of still another embodiment, a single substrate may be used so that the thickness may be reduced to more secure flexibility.

FIGS. 19 to 22 are sectional views of a touch window including a display panel according to still another embodiment. Referring to FIG. 19, a touch window may be formed by coupling a substrate 100 and a display panel 600 to each other. The substrate 100 and the display panel 600 may adhere to each other through an adhesive layer 700. For example, the substrate 100 and the display panel 600 may be bonded to each other through the adhesive layer 700 including an optical clear adhesive (OCA).

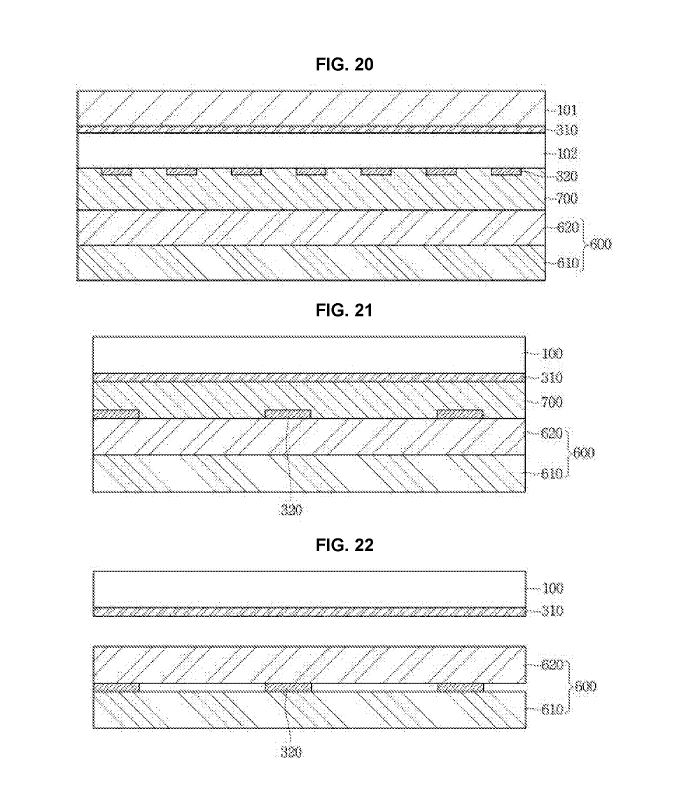

Referring to FIG. 20, when the second substrate 102 is further provided on the first substrate 101, the touch window may be formed by coupling the substrate 100 and the display panel 600. The second substrate 102 and the display panel 600 may adhere to each other through the adhesive layer 700. For example, the first substrate 101 and the display panel 600 may be bonded to each other through the adhesive layer 700 including optical clear adhesive (OCA).

The display panel 600 may include first and second panel substrates 610 and 620. If the display panel 600 is a liquid crystal display panel, the display panel 600 may have a structure in which the first panel substrate 610 including a thin film transistor (TFT) and a pixel electrode may be combined with the second panel substrate 620 including color filter layers while a liquid crystal layer is interposed between the first and second panel substrates 610 and 620.

Further, the display panel 600 may be a liquid crystal display panel having a color filter on transistor (COT) structure formed by combining the first panel substrate 610 formed thereon with the TFT, a color filter, and a black matrix with the second panel substrate 620 while the liquid crystal layer is interposed between the first and second panel substrates 610 and 620. That is, the TFT may be formed on the first panel substrate 610, a protective layer may be formed on the TFT, and the color filter layer may be formed on the protective layer. In addition, the pixel electrode, which makes contact with the TFT, may be formed on the first panel substrate 610. In this case, to improve an aperture ratio and simplify a mask process, the black matrix may be omitted, and a common electrode may perform a function of the black matrix together with the inherent function thereof. If the display panel 600 is a liquid crystal panel, the display device may further include a backlight unit for providing light at the back of the display panel 600.

When the display panel 600 is an organic electroluminescence display panel, the display panel 600 may include a self light-emitting device that may not require any additional light source. A thin film transistor may be formed on the first panel substrate 610 of the display panel 600, and an organic light-emitting device (OLED) making contact with the thin film transistor may be formed. The OLED may include an anode, a cathode and an organic light-emitting layer formed between the anode and the cathode. In addition, the display panel 600 may further include the second panel substrate 620, which may perform the function of an encapsulation substrate 100 for encapsulation, on the OLED.

Referring to FIG. 21, a touch device according to an embodiment may include a touch panel formed integrally with the display panel 600. That is, a substrate 100 supporting at least one sensing electrode 300 may be omitted. At least one sensing electrode 300 may be provided on at least one surface of the display panel 600. That is, at least one sensing electrode 300 may be formed on at least one surface of the first or second panel substrate 610 or 620. At least one sensing electrode 300 may be formed on a top surface of the substrate 100 provided at an upper portion.

Referring to FIG. 21, the first sensing electrode 301 may be provided on one surface of the substrate 100. A first wire connected to the first sensing electrode 301 may be provided on the one surface of the substrate 100. The second sensing electrode 302 may be provided on one surface of the display panel 600. Further, the second wire connected to the second sensing electrode 302 may be provided on the one surface of the display panel 600.

The adhesive layer 700 may be provided between the substrate 100 and the display panel 600 so that the substrate 100 may be combined with the display panel 600.

The substrate 100 may further include a polarizing plate below the substrate 100. The polarizing plate may be a linear polarizing plate or an anti-reflection polarizing plate. For example, when the display panel 600 is a liquid crystal display panel, the polarizing plate may be a linear polarizing plate. When the display panel 600 is an organic electroluminescent display panel, the polarizing plate may be an anti-reflection polarizing plate.

According to a touch window of an embodiment, at least one substrate 100 for supporting the sensing electrode 300 may be omitted so that the thickness of the touch window may be thinner.

Referring to FIG. 22, a touch window according to an embodiment may include a touch panel integrated with the display panel 600. That is, the substrate 100 for supporting at least one sensing electrode 300 may be omitted. For example, a sensing electrode 300, which may serve as a sensor provided in an active area to sense a touch, and a wire, through which an electrical signal may be applied to the sensing electrode 300, may be formed inside the display panel. At least one sensing electrode 300 or at least one wire may be provided inside the display panel.

The display panel 600 may include the first and second substrates 610 and 620. At least one of the first and second sensing electrodes 301 and 302 may be provided between the first and second panel substrates 610 and 620. That is, at least one sensing electrode 300 may be provided on at least one surface of the first or second panel substrate 610 or 620.

Referring to FIG. 22, the first sensing electrode 301 may be provided on one surface of the substrate 100. The first wire connected to the first sensing electrode 301 may be provided. Further, the second sensing electrode 302 and the second wire may be formed between the first and second panel substrates 610 and 620. That is, the second sensing electrode 302 and the second wire may be provided inside the display panel, and the first sensing electrode 301 and the first wire may be provided outside the display panel 600.

The second sensing electrode 302 and the second wire may be provided on a top surface of the first panel substrate 610 or a rear surface of the second panel substrate 620. In addition, a polarizing plate may be further provided at a lower portion of the substrate 100.

When the display panel is a liquid crystal display panel and the second sensing electrode 302 is formed on the top surface of the first substrate 610, the sensing electrode 300 may be formed with a thin film transistor (TFT) or a pixel electrode. When the second sensing electrode 302 is formed on the rear surface of the second panel substrate 620, a color filter layer may be formed on the sensing electrode 300 or the sensing electrode 300 may be formed on the color filter layer. When the display panel is an organic electroluminescence display panel and the second sensing electrode 302 is formed on the top surface of the first panel substrate 610, the second sensing electrode 302 may be formed with a thin film transistor or an organic light-emitting device.

The touch window according to an embodiment may allow at least one substrate 100 supporting the sensing electrode 300 to be omitted. Thus, the touch device may be thin and may have a light weight. In addition, the sensing electrode 300 and the wire may be formed with a device formed on the display panel so that manufacturing may be simplified and costs may be reduced.

When the display panel is folded, folding stress may be applied to the touch window described in FIGS. 19 to 22, and reliability may deteriorate.

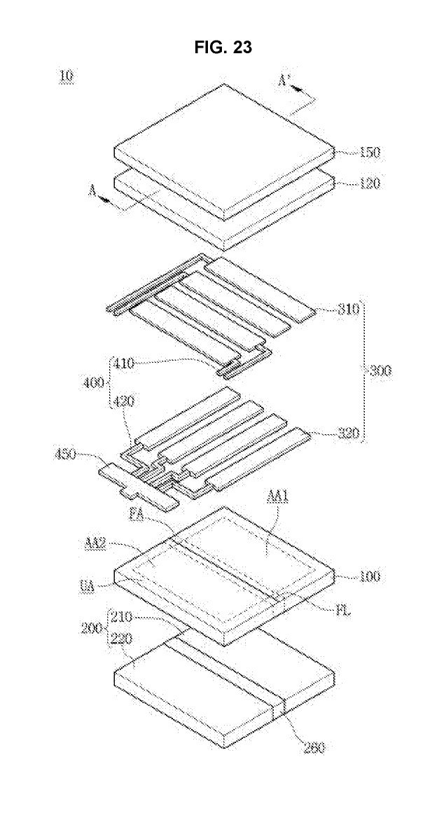

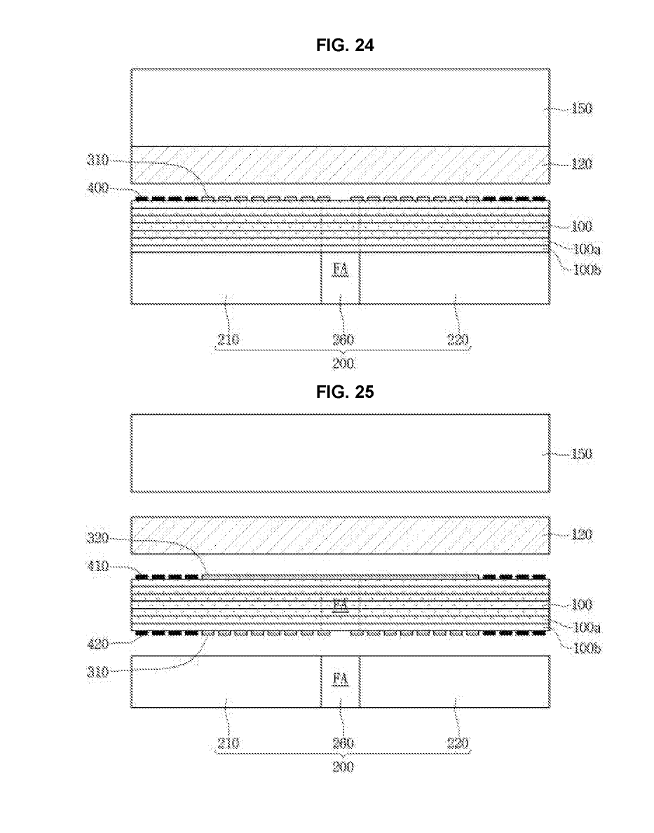

FIG. 23 is an exploded perspective view of a touch window including a display panel according to an embodiment. FIG. 24 is a sectional view taken along line A-A′ of FIG. 23. A touch window 10 according to an embodiment may include a substrate 100 including first and second barrier layers 100a and 100b, a cover substrate 150, a sensing electrode 300, a wire electrode 400 and a display panel 200.

Hereinafter, for the purpose of convenient description, areas of the cover substrate 150 which overlap the active area AA, the unactive area UA and the folding area FA of the touch window, respectively, may be referred to as an active area AA, an unactive area UA and a folding area FA of the cover substrate 150. Areas of the substrate 100 which overlap the active area AA, the unactive area UA and the folding area FA of the touch window, respectively, may be referred to as an active area AA, an unactive area UA and a folding area FA of the substrate 100.

At least a portion of the cover substrate 150 may be flexible. For example, the entire cover substrate 150 may be flexible. Alternatively, the folding area FA of the cover substrate 150 may be flexible and the active area AA and the unactive area UA of the cover substrate 150 may be rigid. That is, the cover substrate 150 may include different materials according to the areas thereof.

A polarizing plate 120 may be provided on the cover substrate 150. The polarizing plate 120 and the cover substrate 150 may be combined with each other through an adhesive layer. The substrate 100 may be provided on the polarizing plate 120.

At least a portion of the substrate 100 may be flexible. For example, the entire substrate 100 may be flexible. Alternatively, the folding area FA of the substrate 100 may be flexible and the active area AA and the unactive area UA of the substrate 100 may be rigid. That is, the cover substrate 150 may include different materials according to the areas thereof.

The substrate may serve as a barrier for protecting the display panel 200 from foreign substances, such as, e.g., moisture. The substrate may include a plurality of barriers. That is, the substrate 100 may include at least one first barrier layer 100a and at least one second barrier layer 100b.

The first barrier layer 100a may include an inorganic material. For example, the first barrier layer 100a may include SiOₓ or AlₓO_{y}. The second barrier layer 100b may include an organic material. For example, the second barrier layer 100b may include EVA, Parylene, PP, EVOH, Nylon, PVA, PE, PVC or PDVC. The first and second barriers 100a and 100b may be stacked while alternating repeatedly.

The substrate 100 may be formed by stacking alternatively and repeatedly the first barrier layer 100a including an inorganic material and the second barrier layer 100b including an organic material so that impurity transmittance may be greatly reduced, thereby effectively protecting the display panel 200. In addition, the substrate 100 having the above-described structure may be highly resistant to the folding stress applied in folding, so that reliability of the touch window may be improved.

A sensing electrode 300 may be provided on the substrate 100. The sensing electrode 300 may include first and second sensing electrodes 310 and 320. The first sensing electrode 310 may be provided on the active area AA of the substrate 100 while extending in a first direction. The first sensing electrode 310 may be provided to make direct contact with the substrate 100.

The second sensing electrode 320 may be provided on the active area AA of the substrate 100 while extending in a second direction. The second sensing electrode 320 may extend in the second direction different from the first direction and may be provided to make direct contact with the same surface of the substrate 100. That is, the first and second sensing electrodes 310 and 320 may be provided to make direct contact with the same surface of the surface 100 and may extend in mutually different directions on the same surface of the substrate 100.

The first and second sensing electrodes 310 and 320 may be provided on the substrate 100 while being insulated from each other. For example, a bridge electrode may be provided on one surface of the substrate 100 on which the sensing electrode 300 may be provided. For example, the bridge electrode may be provided in a bar form. Bridge electrodes may be spaced apart from each other by a predetermined interval on the active area AA in the bar form. An insulating material may be provided on the bridge electrode. An insulating material may be partially provided on the bridge electrode and a part or portion of the bridge electrode may be coated with the insulating material. For example, when the bridge electrode is formed in a bar form, the insulating material may be provided on an area except for a first end and a second opposite end, that is, both ends of the bridge electrode. The first sensing electrodes 310 may extend while being connected to each other on the insulating material. Thus, the first and second sensing electrodes 310 and 320 may be electrically connected to the bridge electrode without being short-circuited with each other due to the insulating material.

The sensing electrode 300 may include a transparent conductive material that allows electricity to flow therethrough without interrupting transmission of light.

According to the embodiment, a longitudinal direction of the first sensing electrode 310 extending in the first direction may be equal to a longitudinal direction of the folding area FA. The first sensing electrode 310 may include metal oxide having excellent visibility, such as, e.g., indium tin oxide (ITO), indium zinc oxide (IZO), copper oxide, tin oxide, zinc oxide, or titanium oxide. However, the metal oxide may be weak when the folding stress is applied when the touch window is folded or unfolded.

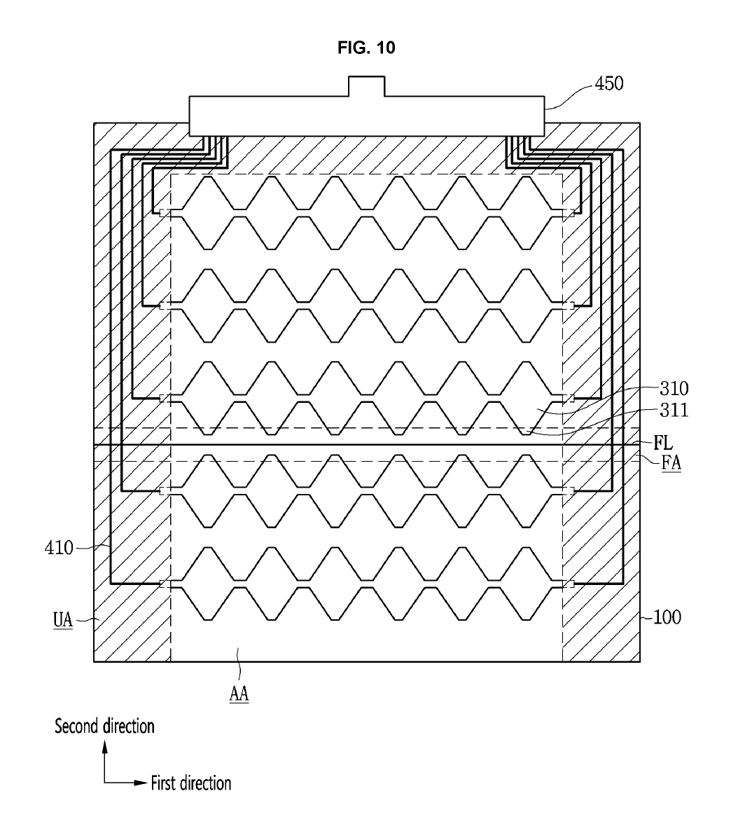

Thus, the folding area FA may be provided between the patterns of the first sensing electrode 310 in the substrate 100. That is, by providing the folding area FA, in which the folding stress may be at a maximum when the touch window is folded, between the patterns of the first sensing electrode 310, the folding stress applied to the first sensing electrode 310 may be minimized. That is, the first sensing electrode 310 may be formed as the above-described embodiments shown in FIGS. 10 to 12.

The folding area FA may be provided on a central portion of the adjacent patterns of the first sensing electrode 310 and may be provided between the patterns of the first sensing electrode 310. A folding line FL, which may serve as a center of the folding area FA, may be provided between the patterns of the first sensing electrode 310.

The second sensing electrode 320 extending in the second direction may include an area 325 that overlaps the folding area FA extending in the first direction. That is, the second sensing electrode 320 may be formed as in the above-described embodiments shown in FIGS. 13 and 15. Thus, the second sensing electrode 320 may receive the folding stress when the touch window is folded.

In order to prevent the second sensing electrode 320 from being damaged due to the folding stress, at least a part or portion of the second sensing electrode 320 may include a nano wire, a photo sensitive nano wire film, a carbon nano tube (CNT), graphene, conductive polymer or a mixture thereof, which is highly resistant to physical stress.

The second sensing electrode 320 or wire electrode 400 may include a mesh shape. The second sensing electrode 320 may include a plurality of sub-electrodes which cross each other in a mesh shape. The second sensing electrode 320 having a mesh shape may include various metals. For example the second sensing electrode 320 may include at least one of Cr, Ni, Cu, Al, Ag, Mo, Au, Ti and the alloy thereof.

The entire second sensing electrode 320 may be formed of a material or in a structure highly resistant to physical stress, or a part or portion 325 that overlaps the folding area FA in the second sensing electrode 320 may be formed of a material or in a structure highly resistant to physical stress.

The wire electrode 400 may be connected to the sensing electrode 300. The wire electrode 400 may be connected to the sensing electrode 300 and may be provided on the unactive area UA of the substrate 100. The sensing electrode 300 may include a conductive material. For example, the wire electrode 400 may include a material the same as the sensing electrode 300 described above.

A plurality of display panels 200 may be provided on the substrate 100. A first display panel 210 may be provided on the first active area AA1 of the substrate 100, and a second display panel 220 may be provided on the second active area AA2 of the substrate 100. A dummy part or portion 260 may be provided on the folding area FA of the substrate 100.

The first and second display panels 210 and 220 may be rigid. Since the display panel 200 is not provided on the folding area FA, the display panel 200 may not receive folding stress.

The first and second display panels 210 and 220 may be organic electroluminescence display panel 200. The organic electroluminescence display panel 200 may include a self light-emitting device that may not require any additional light source. A thin film transistor may be formed on the organic electroluminescence display panel 200 and an organic light-emitting device (OLED) making contact with the thin film transistor may be provided on the organic electroluminescence display panel 200. The OLED may include an anode, a cathode and an organic light-emitting layer formed between the anode and the cathode. In addition, the organic electroluminescence display panel 200 may further include an encapsulation substrate for encapsulation on the OLED.

Since the organic electroluminescence display panel 200 does not require any additional light sources, the thickness of the organic electroluminescence display panel 200 may be thin so that the organic electroluminescence display panel 200 may be suitable for a touch window. According to an embodiment, at least two rigid organic electroluminescence display panels 200 may be provided so that the rigid organic electroluminescence display panels may not be provided on the folding area FA, and limitations caused by folding may be relieved.

The dummy part or portion 260 may be provided on the folding area FA. For example, the dummy part or portion 260 may be provided between the first and second display panels 210 and 220. The dummy part or portion 260 may be provided to allow a side surface of the first display panel 210 to make contact with a side surface of the second display panel 220, where the side surface of the first display panel 210 faces the side surface of the second display panel 220. The dummy part or portion 260 may be connected to the display panel 200 such that the display panel may be movable with respect to the dummy part or portion 260. That is, the dummy part may be formed of a flexible material.

The touch window may be formed in many various structures. FIGS. 25 to 28 are sectional views of touch windows according to various embodiments.

Referring to FIG. 25, the touch window according to still another embodiment may include a cover substrate 150, a sensing electrode 300, a wire electrode 400, a substrate 100 including first and second barrier layers 100a and 100b, and a display panel 200. A polarizing plate 120 may be provided on the cover substrate 150. The substrate 100 may be provided on the polarizing plate 120.

The first and second sensing electrode 310 and 320 may be provided on the substrate 100. The first sensing electrode 310 extending in one direction and the first wire electrode 410 connected to the first sensing electrode 310 may be provided on one surface of the substrate 100, and the second sensing electrode 320 extending in a direction different from the one direction and the second wire electrode 420 connected to the second sensing electrode 320 may be provided on the opposite surface of the substrate 100.

At least two display panels 200 may be provided on the substrate 100. The first display panel 210 may be provided on the first active area AA1 of the substrate 100, and the second display panel 220 may be provided on the second active area AA2 of the substrate 100. The dummy part or portion 260 may be provided on the folding area FA of the substrate 100.

The touch window according to still another embodiment may not require any additional configurations or structures for insulating the first and second sensing electrodes 310 and 320 so that insulating may be easily performed and a structure may simplified. The structure of the touch window may be simplified so that the touch window may be highly resistant to folding stress, thereby improving reliability.

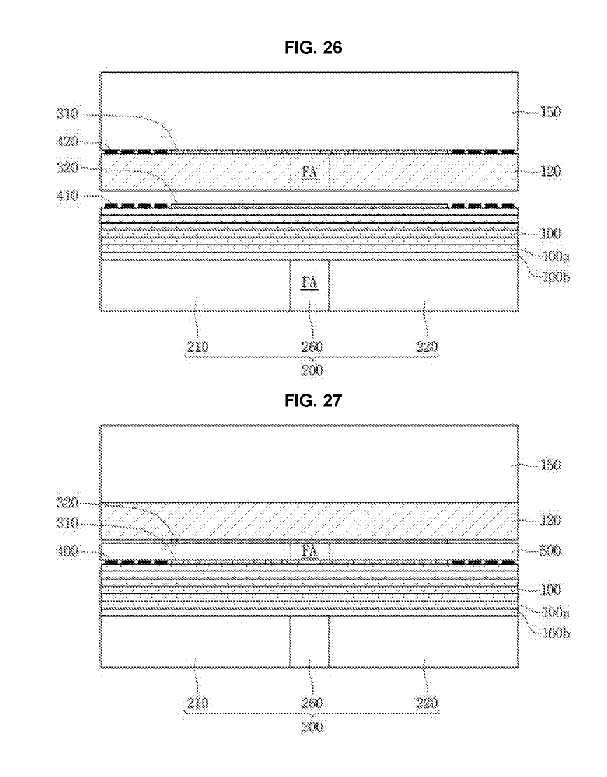

Referring to FIG. 26, the touch window according to still another embodiment may include a cover substrate 150, a sensing electrode 300, a wire electrode 400, a substrate 100 including first and second barrier layers 100a and 100b, and a display panel 200. A polarizing plate 120 may be provided on the cover substrate 150. The substrate 100 may be provided on the polarizing plate 120.

The first sensing electrode 310 and the first wire electrode 410 may be provided on the substrate 100. The second sensing electrode 320 and the second wire electrode 420 may be provided on the cover substrate 150.

At least two display panels 200 may be provided on the substrate 100. The first display panel 210 may be provided on the first active area AA1 of the substrate 100, and the second display panel 220 may be provided on the second active area AA2 of the substrate 100. The dummy part or portion 260 may be provided on the folding area FA of the substrate 100.

The touch window according to still another embodiment may not require any additional configurations or structures for insulating the first and second sensing electrodes 310 and 320, so that insulating may be easily performed and a structure may be simplified. The structure of the touch window may be simplified so that the touch window may be highly resistant to folding stress, thereby improving reliability.

Referring to FIG. 27, the touch window according to still another embodiment may include a cover substrate 150, a sensing electrode 300, a wire electrode 400, an intermediate layer 500, a substrate 100 and a display panel 200. A polarizing plate 120 may be provided on the cover substrate 150. The substrate 100 may be provided on the polarizing plate 120.

The first sensing electrode 310 and the wire electrode 400 may be provided on the substrate 100. The intermediate layer 500 may be provided on the substrate 100. The intermediate layer 500 may be interposed between the polarizing plate 120 and the substrate 100. The second sensing electrode 320 may be provided on the intermediate layer 500.

For example, the intermediate layer 500 may be directly provided on the top surface of the substrate 100. That is, the intermediate layer 500 may be formed by directly coating an insulating material on a top surface of the substrate on which the first sensing electrode 310 may be provided. Then, the second sensing electrode 320 may be provided on the intermediate layer 500.

The intermediate layer 500 may absorb folding stress so that the folding stress applied to the sensing electrode 300 may be reduced. Thus, the intermediate layer 500 may improve the reliability of the touch window.

At least two display panels 200 may be provided on the substrate 100. The first display panel 210 may be provided on the first active area AA1 of the substrate 100, and the second display panel 220 may be provided on the second active area AA2 of the substrate 100. The dummy part or portion 260 may be provided on the folding area FA of the substrate 100.

The touch window according to still another embodiment may not require any additional configurations or structures for insulating the first and second sensing electrodes 310 and 320, so that insulating may be easily performed and a structure may be simplified. The structure of the touch window may be simplified so that the touch window may be highly resistant to folding stress, thereby improving reliability.

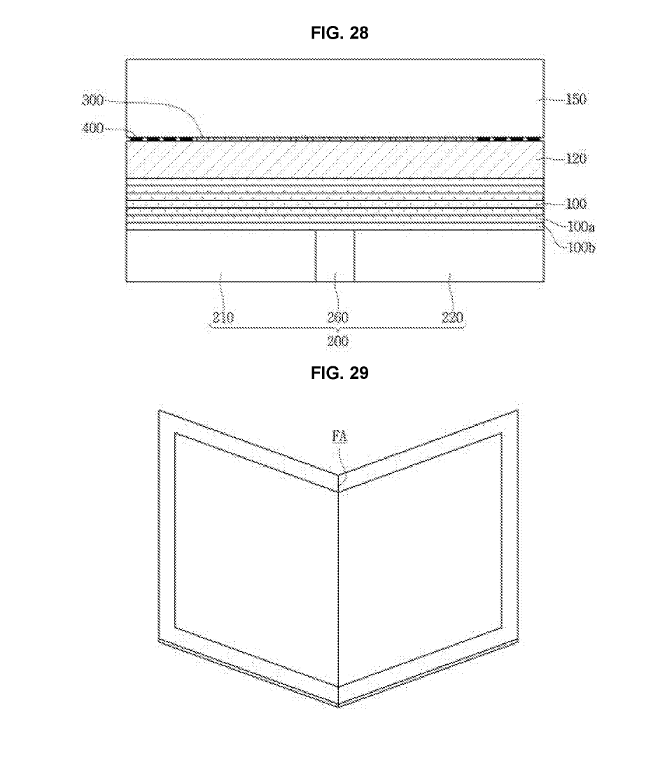

Referring to FIG. 28, the touch window according to still another embodiment may include a cover substrate 150, a sensing electrode 300, a wire electrode 400, an intermediate layer 500, a substrate 100 and a display panel 200. A polarizing plate 120 may be provided on the cover substrate 150. The substrate 100 may be provided on the polarizing plate 120.

At least two display panels 200 may be provided on the substrate 100. The first display panel 210 may be provided on the first active area AA1 of the substrate 100, and the second display panel 220 may be provided on the second active area AA2 of the substrate 100. The dummy part or portion 260 may be provided on the folding area FA of the substrate 100.

The first and second sensing electrodes 310 and 320 may be provided on the cover substrate 150. The first and second sensing electrodes 310 and 320 may be provided to make contact with the cover substrate 150. In this case, a resin layer may be further provided between the cover substrate 150 and the sensing electrode 300. The resin layer may reinforce the cover substrate 150 and may protect the sensing electrode 300 so that the reliability of the foldable touch window may be improved.

The first sensing electrode 310 may be provided on the active area AA of the cover substrate 150 while extending in the first direction. The first sensing electrode 310 may be provided to make direct contact with the cover substrate 150. In addition, the second sensing electrode 320 may be provided on the active area AA of the cover substrate 150 while extending in the second direction. The second sensing electrode 320 may extend in the second direction different from the first direction and may be provided to make direct contact with the cover substrate 150. That is, the first and second sensing electrodes 310 and 320 may be provided to make direct contact with the same surface of the surface 100 and may extend in different directions on the same surface of the cover substrate 150.

The first and second sensing electrodes 310 and 320 may be provided on the cover substrate 150 while being insulated from each other. For example, a bridge electrode may be provided on one surface of the substrate 100 on which the sensing electrode 300 is provided. For example, the bridge electrode may be provided in a bar form. Bridge electrodes may be spaced apart from each other by a predetermined interval on the active area AA in the bar form. An insulating material may be provided on the bridge electrode. An insulating material may be partially provided on the bridge electrode and a part of the bridge electrode may be coated with the insulating material. For example, when the bridge electrode is formed in a bar form, the insulating material may be provided on an area except for one end and the opposite end, that is, both ends of the bridge electrode.

The first sensing electrodes 310 may extend while being connected to each other on the insulating material. For example, the first sensing electrodes 310 may extend in the first direction while being connected to each other on the insulating material. In addition, the second sensing electrodes 320 may be provided while being connected to the bridge electrode. The second sensing electrodes 320 may be connected to the bridge electrode while being spaced apart from each other so that the second sensing electrodes 320 may extend in the second direction. Thus, the first and second sensing electrodes 310 and 320 may be electrically connected to the bridge electrode without being short-circuited with each other due to the insulating material.

FIGS. 29 to 32 are views showing examples of a touch device to which a touch window is applied according to embodiments disclosed herein. Referring to FIGS. 29 and 30, the touch window may be applied to a touch device such as a mobile terminal. The touch device may include a touch window including a folding area FA that allows the touch device to be folded or unfolded. Thus, the touch device may be folded or unfolded based on the folding area FA. The folding function may be utilized for various design elements and to improve portability.

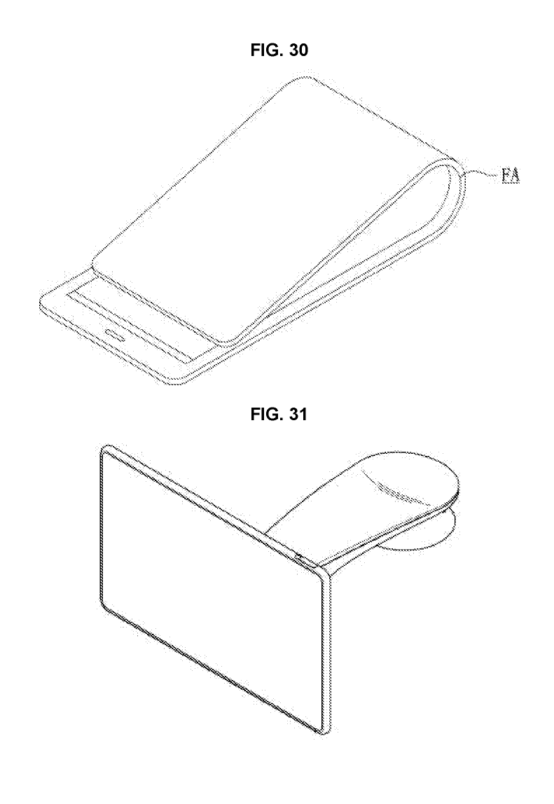

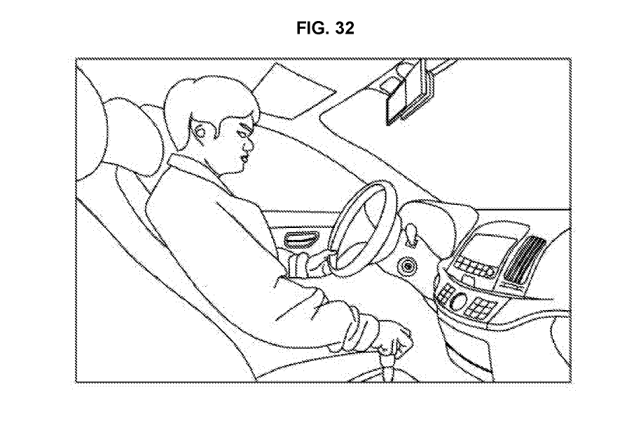

Referring to FIG. 31, the touch window may be applied to a vehicle navigation system. Referring to FIG. 32, the touch window may be applied inside a vehicle. That is, the touch window may be applied to various parts in the vehicle to which the touch window may be applicable. Accordingly, the touch window may be applied to a dashboard as well as a PND (Personal Navigation Display), thereby realizing a CID (Center Information Display). However, the embodiment is not limited to the above, and the touch device may be used in various electronic products.

Embodiments disclosed herein may provide a foldable touch window having high reliability.

According to an embodiment disclosed herein, a touch window may include a substrate including an active area, an unactive area and a folding area defined therein, a sensing electrode on the substrate, a wire electrode electrically connected to the sensing electrode and provided on the substrate, and a printed circuit board connected to the wire electrode, wherein the sensing electrode includes a first sensing electrode extending in a first direction, the first sensing electrode including a plurality of patterns, and a folding line serving as a center of the folding area is provided between the plurality of patterns of the first sensing electrode.

According to embodiments disclosed herein, the touch window may be folded or unfolded, so that the touch window may be utilized as a design element and may have improved portability.

In addition, according to embodiments, the touch window may relieve folding stress generated when the touch window is folded or unfolded so that reliability may be improved.

According to the touch window of embodiments disclosed herein, the sensing electrode may be provided to avoid folding stress so that reliability may be improved. In addition, a conductive material having good flexibility may be used for the sensing electrode receiving the folding stress, so that reliability may be improved.

At least a part or portion of the sensing electrode may be formed of a material having good visibility so that visibility may be improved.

According to another embodiment disclosed herein, a touch window may include a cover substrate, a substrate provided on the cover substrate and including an active area, an unactive area and a folding area defined therein, a sensing electrode on the active area of the substrate, a wire electrode electrically connected to the sensing electrode and provided on the substrate, a printed circuit board connected to the wire electrode, at least two display panels provided on the active area of the substrate, and a dummy part or portion provided on the folding area of the substrate.

The touch window may be folded or unfolded so that the touch window may be utilized as a design element and may have improved portability. When impact is applied to the touch window, the impact may be absorbed through the folding so that reliability of the touch window may be improved.

The substrate may include a first barrier layer including an inorganic material and a second barrier layer including an organic material, so that impurity transmittance may be greatly reduced, thereby effectively protecting the display panel. In addition, the substrate having the above-described structure may be highly resistant to folding stress applied during folding so that the reliability of the touch window may be improved.

The display panel may be an organic electroluminescence display panel. Since the organic electroluminescence display panel may not require any additional light sources, the thickness of the organic electroluminescence display panel may be thin so that the organic electroluminescence display panel may be suitable for a touch window. According to an embodiment disclosed herein, at least two rigid organic electroluminescence display panels may be provided such that the rigid organic electroluminescence display panels may not be provided on the folding area, and limitations caused by the folding may be relieved.

In addition, the touch window may not require any additional configurations or structures for insulating the first and second sensing electrodes, so that insulating may be easily performed and the structure may be simplified. The structure of the touch window may be simplified so that the touch window may be highly resistant to folding stress, thereby improving reliability.

The touch window may include an intermediate layer to absorb folding stress so that the folding stress applied to the sensing electrode may be reduced. Thus, reliability of the touch window may be improved.

According to still another embodiment, there may be provided a touch window which may include a substrate including an active area, an unactive area and a folding area defined therein, a sensing electrode on the substrate, a wire electrode electrically connected to the sensing electrode and provided on the substrate, a printed circuit board connected to the wire electrode, and at least two display panels provided on the active area of the substrate, wherein the sensing electrode includes a plurality of patterns, a folding line serving as a center of the folding area is provided between the plurality of patterns of the sensing electrode, and a dummy part or portion is provided on the folding area of the substrate.

It will be understood that, when a layer (or film), a region, a pattern, or a structure is referred to as being “on” or “under” another substrate, another layer (or film), another region, another pad, or another pattern, it can be “directly” or “indirectly” on the other substrate, layer (or film), region, pad, or pattern, or one or more intervening layers may also be present. Such a position of the layer has been described with reference to the drawings.

When a part is connected to the other part, the parts are not only directly connected to each other, but also indirectly connected to each other while interposing another part therebetween. In addition, when a predetermined part “includes” a predetermined component, the predetermined part does not exclude other components, but may further include other components unless otherwise indicated.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A touch window comprising:
a substrate including an active area, an unactive area and a folding area;
a sensing electrode provided on the substrate;
a wire electrode electrically connected to the sensing electrode and provided on the substrate; and
a printed circuit board connected to the wire electrode,
wherein the sensing electrode includes a first sensing electrode extending in a first direction, the first sensing electrode including a plurality of patterns and a folding line serving as a center of the folding area is provided between the plurality of patterns of the first sensing electrode.

2. The touch window of claim 1, wherein at least two folding areas are defined on the substrate.

3. The touch window of claim 1, wherein the sensing electrode further includes a second sensing electrode extending in a second direction.

4. The touch window of claim 1, wherein a distance between the plurality of patterns of the first sensing electrode adjacent to the folding line is longer than a distance between other plurality of patterns of the first sensing electrode.

5. The touch window of claim 1, wherein a distance between the plurality of patterns of the first sensing electrode adjacent to the folding line is longer than a width of the folding area.

6. The touch window of claim 3, wherein the second sensing electrode is formed of a material different from a material of the first sensing electrode.

7. The touch window of claim 6, wherein the first sensing electrode includes indium tin oxide, indium zinc oxide, copper oxide, tin oxide, zinc oxide, titanium oxide or a mixture thereof, and
the second sensing electrode includes a nano wire, a photo sensitive nano wire film, a carbon nano tube, graphene, conductive polymer or a mixture thereof.

8. The touch window of claim 6, wherein the first sensing electrode includes indium tin oxide, indium zinc oxide, copper oxide, tin oxide, zinc oxide, titanium oxide or a mixture thereof, and
the second sensing electrode is formed of a metal having a mesh pattern.

9. The touch window of claim 1, wherein the first sensing electrode is divided into an upper first sensing electrode and a lower first sensing electrode based on the folding line, and
the wire electrode includes a first sub-wire electrode connected to the upper first sensing electrode and a second sub-wire electrode connected to the lower first sensing electrode.

10. The touch window of claim 3, wherein the second sensing electrode includes an opening portion provided in the folding area.

11. A touch window comprising:
a cover substrate;
a substrate provided on the cover substrate and including an active area, an unactive area and a folding area;
a sensing electrode on the active area of the substrate;
a wire electrode electrically connected to the sensing electrode and provided on the substrate;
a printed circuit board connected to the wire electrode;
at least two display panels provided on the active area of the substrate; and
a dummy portion provided on the folding area of the substrate.

13. The touch window of claim 11, wherein the active area is divided into a first active area and a second active area based on the folding area, and the touch window further includes a first display panel provided on the first active area and a second display panel provided on the second active area.

14. The touch window of claim 13, wherein the folding area is provided between a side surface of the first display panel and a side surface of the second display panel facing the side surface of the first display panel.

15. The touch window of claim 11, wherein the substrate includes a plurality of barrier layers.

16. The touch window of claim 15, wherein the barrier layer includes at least one first barrier layer and at least one second barrier layer, and
wherein the first barrier layer includes an inorganic material and the second barrier layer includes an organic material.

17. The touch window of claim 11, wherein the sensing electrode includes a first sensing electrode extending in a first direction and a second sensing electrode extending in a second direction different from the first direction.

18. The touch window of claim 17, further comprising an intermediate layer provided on a top surface of the substrate, wherein the second sensing electrode is provided on the intermediate layer.

19. The touch window of claim 17, wherein the first sensing electrode contacts with a first surface of the substrate, and the second sensing electrode contacts a second surface of the substrate opposite the first surface of the substrate.

20. The touch window of claim 11, wherein the display panel includes an organic electroluminescence light emitting display panel.

21. A touch window comprising:
a substrate including an active area, an unactive area and a folding area;
a sensing electrode on the substrate;
a wire electrode electrically connected to the sensing electrode and provided on the substrate;
a printed circuit board connected to the wire electrode; and
at least two display panels provided on the active area of the substrate,
wherein the sensing electrode includes a plurality of patterns,
a folding line serving as a center of the folding area is provided between the plurality of patterns of the sensing electrode, and
a dummy portion is provided on the folding area of the substrate.
